(19) United States
(12) Patent Application Publication
(10) Pub. No.: US 2013/0207764 A1
(43) Pub. Date: Aug. 15, 2013

(54) INDUCTOR FOR SURFACE MOUNTING

(71) Applicants: Hsiu Fa YEH, Hsinchu (TW); Pin Yu CHEN, Hsinchu (TW); Hang Chun LU, Hsinchu (TW); Chen Kuo WEN, Hsinchu (TW)

(72) Inventors: Hsiu Fa YEH, Hsinchu (TW); Pin Yu CHEN, Hsinchu (TW); Hang Chun LU, Hsinchu (TW); Chen Kuo WEN, Hsinchu (TW)

(21) Appl. No.: 13/396,782

(22) Filed: Feb. 15, 2012

(51) Int. Cl. H01F 27/29

(52) U.S. Cl. 336/65

(57) ABSTRACT

An inductor includes a base device having a parallelepiped chamber formed by two side surfaces and two end surfaces, a parallelepiped conductive device engaged into the parallelepiped chamber of the base device and having a parallelepiped compartment and having two terminals engaged onto an upper surface of the base device, and a core engaged into the parallelepiped compartment of the conductive device. The conductive device is planar and includes a rectangular cross section having a reduced dimension or structure for allowing the inductor to be easily and quickly and attached onto the surfaces of the electric circuit boards with surface mount devices.

### BACKGROUND OF THE INVENTION

1. Field of the Invention

The present invention relates to an inductor, and more particularly to an inductor including a reduced size or dimension or structure for allowing the inductor to be suitably and easily and quickly and readily attached or mounted or secured onto the surfaces of the electric circuit boards or the like.

2. Description of the Prior Art

Typical inductors have been developed and provided for inducing the current and comprise one or more cores and one or more coils or conductive members for inducing or generating the current.

For example, U.S. Pat. No. 5,751,203 to Tsutsumi et al. discloses one of the typical inductors also comprising one or more coils or conductive members engaged into a drum-shaped core for inducing or generating the current, and a cylindrical core disposed around the drum-shaped core and the coil, and a terminal table attached or mounted or engaged onto the drum-shaped core and the coil and the cylindrical core.

The typical inductors include a coil having two ends are drawn through a gap that is formed between the terminal table and the drum-shaped core and the coil and the cylindrical core for coupling or connecting to winding terminals. However, the ends of the coil may not be easily and quickly and readily attached or mounted or secured onto the surfaces of the electric circuit boards or the like with working machines, and should be mounted manually such that the specialized or trained workers may take a long time to mount the typical inductors manually. In addition, an electric insulating material is required to be applied onto the outer peripheral portion of the coil for preventing the short circuit of the coil from being generated.

U.S. Pat. No. 6,154,112 to Aoba et al. discloses another typical chip inductor comprising a coil or winding attached or mounted or engaged onto the winding core and disposed or located between end flanges.

Normally, the coil or winding includes a longitudinal and cylindrical structure that may occupy a large volume for the typical chip inductor, and the ends of the coil or winding should be hammered or squeezed before the ends of the coil or winding can be attached or mounted or secured onto the surfaces of the electric circuit boards or the like, and the typical chip inductor should be mounted onto the surfaces of the electric circuit boards or the like manually by specialized or trained workers. In addition, an electric insulating material is required to be applied onto the outer peripheral portion of the coil or winding for preventing the short circuit of the coil or winding from being generated.

U.S. Pat. No. 7,042,324 to Watanabe discloses a further typical surface mount inductor comprising a coil or winding attached or mounted or engaged onto or wound around a winding shaft section of the drum core, and the winding wire of the typical surface mount inductor also includes a circular cross section, and the terminals of the winding wire are then wound from the outside of the extended portions of the case body and also wound onto the binding terminals.

However, the winding wire that includes a circular cross section may also occupy a large volume, and the terminals of the winding wire also includes a circular cross section and may not be easily and quickly and readily attached or mounted or secured onto the surfaces of the electric circuit boards or the like with working machines, and should be mounted manually such that the specialized or trained workers may take a long time to mount the typical inductors manually. In addition, an electric insulating material is required to be applied onto the outer peripheral portion of the coil or winding wire for preventing the short circuit of the coil or winding wire from being generated.

The present invention has arisen to mitigate and/or obviate the afore-described disadvantages of the conventional inductive members or inductors.

### SUMMARY OF THE INVENTION

The primary objective of the present invention is to provide an inductor including a reduced size or dimension or structure for allowing the inductor to be suitably and easily and quickly and readily attached or mounted or secured onto the surfaces of the electric circuit boards or the like.

In accordance with one aspect of the invention, there is provided an inductor comprising a base device including a chamber formed therein and having a parallelepiped shape defined by two side surfaces and two end surfaces, the base device including an upper surface, a conductive device including a parallelepiped structure engaged into the parallelepiped chamber of the base device and including a parallelepiped compartment formed therein, and including a first terminal and a second terminal extended from the conductive device and engaged onto the upper surface of the base device, and a core engaged into the compartment of the conductive device.

The conductive device includes a planar structure having a rectangular cross section and having a thickness (T) and a width (W). The conductive device includes a first coil element and a second coil element coupled together to form the parallelepiped conductive device.

The first coil element and the second coil element each include a U-shaped structure having a first side panel and a second side panel, and a bottom panel connected between the first and the second side panels respectively.

The conductive device includes a linking conductive element connected between the first side panel of the first coil element and the second side panel of the second coil element. The linking conductive element of the conductive device is parallel to the upper surface of the base device.

The first terminal of the conductive device is extended from the second side panel of the first coil element, and the second terminal of the conductive device is extended from the first side panel of the second coil element. The first and the second side panels of the first and the second coil elements are parallel to the side surfaces of the base device respectively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an inductor in accordance with the present invention;

FIG. 2 is a perspective view of the inductor;

FIG. 3 is a lateral cross sectional view of the inductor;

FIG. 4 is an end plan schematic view of the coil of the inductor;

FIG. 5 is a partial side plan schematic view illustrating the attachment of the inductor onto a surface of an electric circuit board; and

FIG. 6 is a perspective view similar to FIG. 2, illustrating the other arrangement of the inductor.

### DETAILED DESCRIPTION OF THE PREFERRED EMBODIMENT

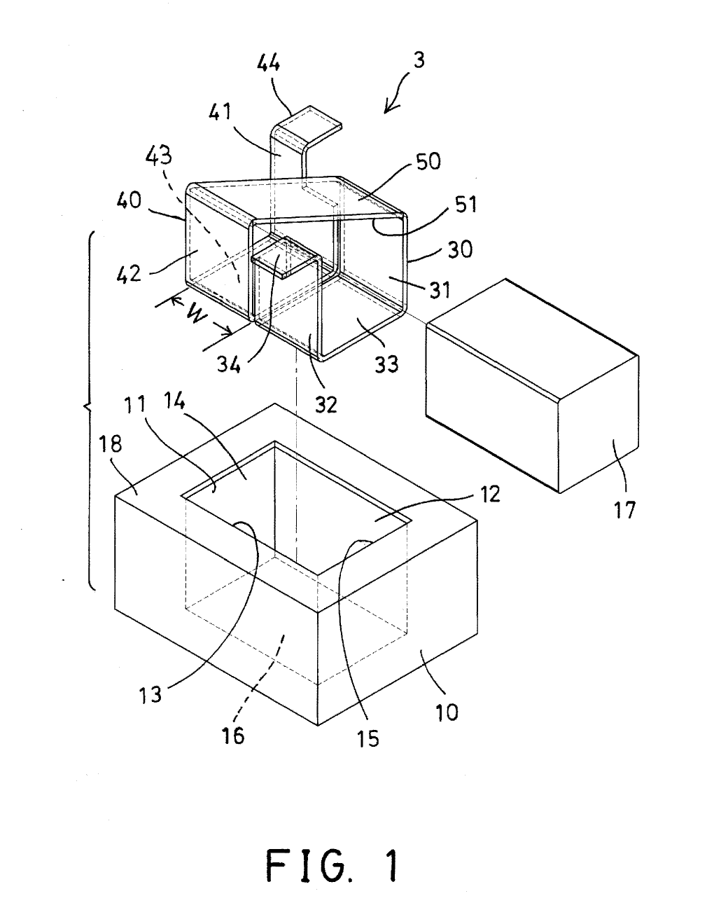

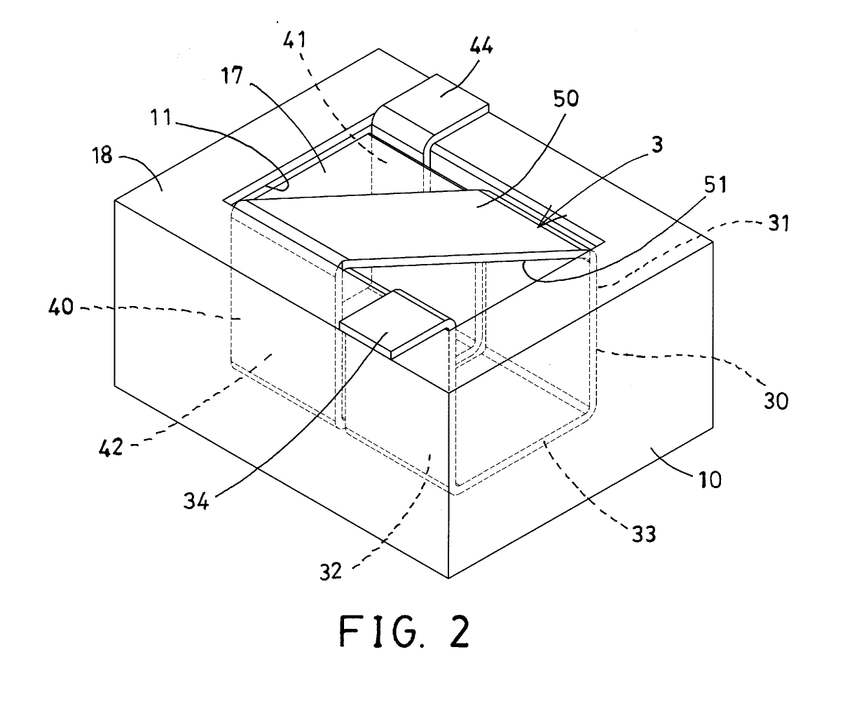

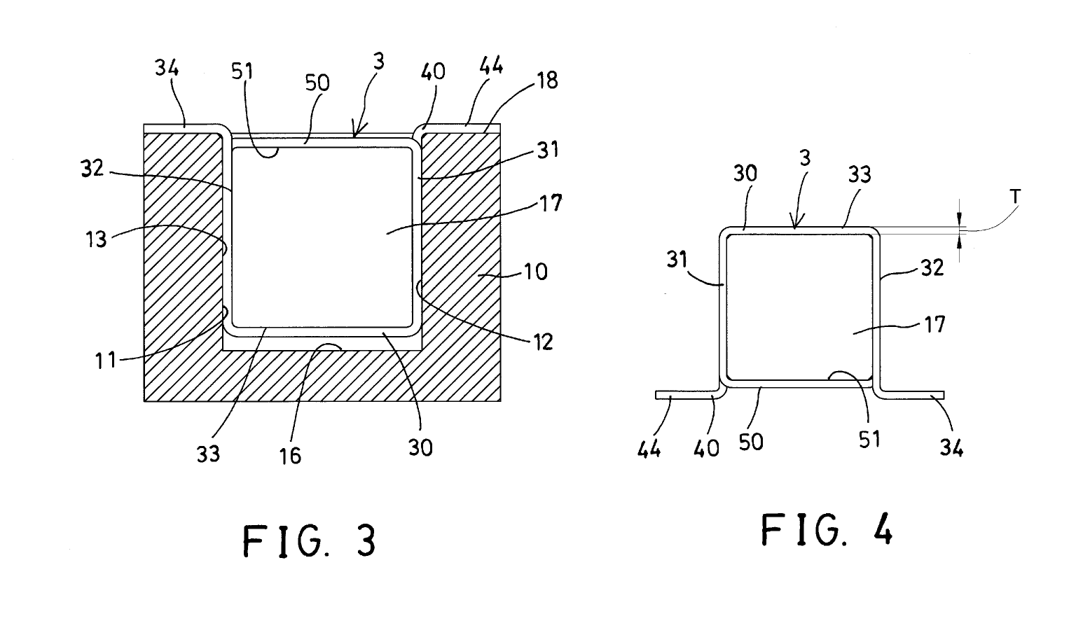

Referring to the drawings, and initially to FIGS. 1-3, an inductor in accordance with the present invention comprises a first or lower or outer core or base device 10 including a chamber 11 formed therein and having a parallelepiped shape or structure and formed or defined by two opposite side surfaces 12, 13, and two opposite end surfaces 14, 15, and/or a bottom wall 16 (FIG. 3), such that the chamber 11 of the base device 10 is opened upwardly, but may also be opened downwardly having no bottom surface formed therein. A second or inner core 17 may further be provided and received or engaged in the chamber 11 of the base device 10.

A coil member or conductive device 3 is further provided and includes one or more (such as two) coil sections or segments or elements 30, 40 each having a U-shaped structure and each having two opposite side panels 31, 32; 41, 42 and a bottom panel 33, 43 connected or coupled between the bottom portions of the side panels 31, 32; 41, 42 respectively for forming the U-shaped structure, and includes a tilted or inclined central linking conductive bar or beam or element 50 connected or coupled between the upper portions of the opposite side panels 31, 42 of the coil elements 30, 40, and flush or aligned with or parallel to the upper surface of the base device 10 for forming the coil-shaped conductive device 3.

The side panels 31, 32; 41, 42 of the coil elements 30, 40 are flush or aligned with or disposed beside or parallel to the side surfaces 12, 13 of the base device 10 respectively, and the bottom panels 33, 43 of the coil elements 30, 40 are flush or aligned with or disposed beside or parallel to the bottom wall 16 of the base device 10 for forming a parallelepiped shape or structure for the coil-shaped conductive device 3 and for forming a parallelepiped compartment 51 within the coil-shaped conductive device 3 and for receiving or engaging with the second or inner core 17.

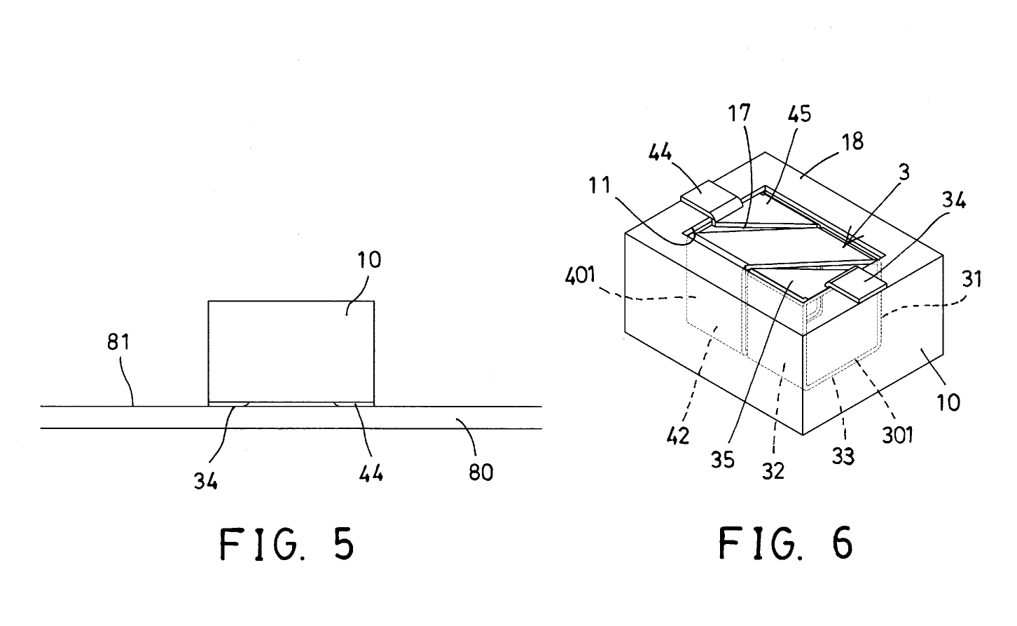

The coil elements 30, 40 each include a terminal 34, 44 extended from the upper portion of the opposite side panels 32, 41 of the coil elements 30, 40, and parallel to the bottom panel 33, 43 of the coil element 30, 40, and extended outwardly from the respective side panel 32, 41 and engaged with or onto the upper surface 18 of the base device 10 (FIG. 3), and attached or mounted or secured to the upper surface 18 of the base device 10 with adhesive materials, by welding processes, or the like, and for allowing the terminals 34, 44 of the coil element 30, 40 and the base device 10 to be suitably and easily and quickly and readily attached or mounted or secured onto the surfaces 81 of the electric circuit boards 80 (FIG. 5) or the like with working machines, or surface mount device (SMD) (not shown) in a mass production.

As shown in FIG. 4, the coil element 30, 40 and the central linking element 50 of the conductive device 3 include a longitudinal and flat and planar structure having a rectangular cross section and having a thickness (T) and a width (W, FIG. 1), and the cross area of the coil element 30, 40 and the central linking element 50 of the conductive device 3 will be thickness (T) times width (W). Accordingly, when the cross area of the coil element 30, 40 and the central linking element 50 of the conductive device 3 is constant or not changed, the greater the width (W) the smaller the thickness (T). When the thickness (T) of the coil element 30, 40 and the central linking element 50 of the conductive device 3 is made smaller, the terminals 34, 44 of the coil element 30, 40 and the base device 10 may be easily and quickly and readily attached or mounted or secured onto the surfaces 81 of the electric circuit boards 80 (FIG. 5) with working machines, or surface mount device (SMD) (not shown) in a mass production.

Alternatively, as shown in FIG. 6, the coil element 301, 401 each may further include an additional extension 35, 45 extended from the upper portion of the opposite side panels 32, 41 of the coil elements 301, 401, and parallel to the bottom panel 33, 43 of the coil element 301, 401, and extended inwardly from the respective side panel 32, 41, and the terminals 34, 44 are extended from the extensions 35, 45 respectively, and engaged with or onto the upper surface 18 of the base device 10, and attached or mounted or secured to the upper surface 18 of the base device 10 with adhesive materials, by welding processes, or the like.

Accordingly, the inductor in accordance with the present invention includes a reduced size or dimension or structure for allowing the inductor to be suitably and easily and quickly and readily attached or mounted or secured onto the surfaces of the electric circuit boards or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An inductor comprising:
a base device including a chamber formed therein and having a parallelepiped shape defined by two side surfaces and two end surfaces, said base device including an upper surface,
a conductive device including a parallelepiped structure engaged into said parallelepiped chamber of said base device and including a parallelepiped compartment formed therein, and including a first terminal and a second terminal extended from said conductive device and engaged onto said upper surface of said base device, and
a core engaged into said compartment of said conductive device.

2. The inductor as claimed in claim 1, wherein said conductive device includes a planar structure having a rectangular cross section and having a thickness (T) and a width (W).

3. The inductor as claimed in claim 1, wherein said conductive device includes a first coil element and a second coil element coupled together to form said parallelepiped conductive device.

4. The inductor as claimed in claim 3, wherein said first coil element and said second coil element each include a U-shaped structure having a first side panel and a second side panel, and a bottom panel connected between said first and said second side panels respectively.

5. The inductor as claimed in claim 4, wherein said conductive device includes a linking conductive element connected between said first side panel of said first coil element and said second side panel of said second coil element.

6. The inductor as claimed in claim 5, wherein said linking conductive element of said conductive device is parallel to said upper surface of said base device.

7. The inductor as claimed in claim 4, wherein said first terminal of said conductive device is extended from said second side panel of said first coil element, and said second terminal of said conductive device is extended from said first side panel of said second coil element.

8. The inductor as claimed in claim 4, wherein said first and said second side panels of said first and said second coil elements are parallel to said side surfaces of said base device respectively.
